(19) United States
(12) Patent Application Publication
(10) Pub. No.: US 2004/0192437 A1
(43) Pub. Date: Sep. 30, 2004

(54) System and method for betting on an event using an auction

(76) Inventors: Lee M. Amaitis, London (GB); Joseph M. Asher, New York, NY (US); Adam Burgis, London (GB); Dominic Crosthwaite, London (GB)

Correspondence Address: BAKER BOTTS L.L.P., 2001 ROSS AVENUE, SUITE 600, DALLAS, TX, 75201-2980, US

(21) Appl. No.: 10/453,557

(22) Filed: Jun. 3, 2003

Related U.S. Application Data
(60) Provisional application No. 60/459,561, filed on Mar. 31, 2003.

(51) Int. Cl. A63F 13/00

(52) U.S. Cl. 463/26

(57) ABSTRACT

A method of managing bets comprises auctioning a first bet to one of a plurality of clients for a first bet amount, wherein the first bet comprises a bet that a first participant will finish in a particular finishing position associated with an event. The method further comprises auctioning a second bet to one of a plurality of clients for a second bet amount, wherein the second bet comprises a bet that a second participant will finish in the particular finishing position associated with the event. The method continues by adding the first bet amount and the second bet amount to form a betting pool, and determining an amount of a payout based at least in part on the betting pool.

### CROSS REFERENCE TO RELATED APPLICATION

This application is related to and claims the benefit of U.S. Provisional Application No. 60/459,561 filed Mar. 31, 2003.

### TECHNICAL FIELD OF THE INVENTION

This invention relates in general to betting on events and, more particularly, to a system and method for betting on an event using an auction.

### BACKGROUND OF THE INVENTION

Wagering on sporting events, such as horse races, for example, is a large and growing industry in many parts of the world. Various types-of betting products or systems are available for various types of sporting events For example, typical horse racing bets allow bettors to bet on a single horse or on several horses in a particular race or series of races. For instance, a bettor can bet on a particular horse to finish first (win), finish in the top two (place), or finish in the top three (show). A bettor may also make various combination bets with multiple horses, such as an exacta bet (covering the top two horses in order) or a trifecta bet (covering the top three horses in order). In addition, a bettor may bet on a series of races, such as the daily double (winners of two consecutive races), the pick-three (winners of three consecutive races), and the pick-six (winners of six consecutive races), for example.

In a pari-mutuel betting system, all bets regarding a particular event are aggregated, a commission (or “take-out”) is taken by the track, and the remainder is distributed among the winning bettors. For example, pari-mutuel betting systems are commonly used in North America (and other various places throughout the world) for betting on horse races.

### SUMMARY OF THE INVENTION

In one embodiment, a method for managing bets comprises auctioning a first bet to one of a plurality of clients for a first bet amount, wherein the first bet comprises a bet that a first participant will finish in a particular finishing position associated with an event. The method continues by auctioning a second bet to one of a plurality of clients for a second bet amount, wherein the second bet comprises a bet that a second participant will finish in the particular finishing position associated with the event. The method concludes by adding the first bet amount and the second bet amount to form a betting pool, and by determining an amount of a payout based at least in part on the betting pool. Of course, the method could including auctioning any suitable number of bets beyond the first bet and the second bet, based upon the number of participants in an event, for example, and adding those bet amounts to the first bet amount and the second bet amount to form the betting pool.

In another embodiment, a system for managing bets comprises a processor and a memory. The memory stores a first bid, a second bid, and a first bet. The first bid identifies a first bid amount and a first participant of a plurality of participants in an event. The second bid identifies a second bid amount and the first participant. The first bet is associated with a first bet amount and comprises a bet that the first participant will finish in a particular finishing position associated with the event. The first bet amount comprises the greater of the first bid amount and the second bid amount. The memory further stores a third bid, a fourth bid, and a second bet. The third bid identifies a third bid amount and a second participant of the plurality of participants in an event. The fourth bid identifies a fourth bid amount and the second participant. The second bet is associated with a second bet amount and comprises a bet that the second participant will finish in the finishing particular position associated with the event. The second bet amount comprises the greater of the third bid amount and the fourth bid amount. The processor adds the first bet amount and the second bet amount to form a betting pool, and determines an amount of a payout based at least in part on the betting pool.

In yet another embodiment, a method for managing bets comprises receiving a first bid identifying a first bid amount and a first participant of a plurality of participants in an event. The method continues by receiving a second bid identifying a second bid amount and the first participant. The method then continues by storing a first bet associated with a first bet amount, wherein the first bet comprises a bet that the first participant will finish in a particular finishing position associated with the event and wherein the first bet amount comprises the greater of the first bid amount and the second bid amount. The method proceeds to receiving a third bid identifying a third bid amount and a second participant of the plurality of participants in an event, and receiving a fourth bid identifying a fourth bid amount and the second participant. The method then continues by storing a second bet associated with a second bet amount, wherein the second bet comprises a bet that the second participant will finish in the finishing particular position associated with the event and wherein the second bet amount comprises the greater of the third bid amount and the fourth bid amount. The method concludes by adding the first bet amount and the second bet amount to form a betting pool, and by determining an amount of a payout based at least in part on the betting pool.

Various embodiments of the present invention may benefit from numerous advantages. It should be noted that one or more embodiments may benefit from some, none, or all of the advantages discussed below.

An advantage is that the auction process allows bettors to bid on bets on particular outcomes of an event. In this way, a bettor may win a large pool by betting a relatively small amount of money on a longshot participant in the event. Other advantages will be readily apparent to one having ordinary skill in the art from the following figures, descriptions, and claims.

### BRIEF DESCRIPTION OF THE DRAWINGS

For a more complete understanding of the present invention and for further features and advantages, reference is now made to the following description, taken in conjunction with the accompanying drawings, in which:

FIG. 1 illustrates a system for auctioning, managing, and paying bets in accordance with an embodiment of the present invention;

FIG. 2 illustrates various equations for calculating the potential payouts for the bets;

FIG. 3 illustrates a table depicting example bet data for various bets; and

FIG. 4 is a flowchart illustrating an example method of auctioning, managing, and paying bets in accordance with an embodiment of the present invention.

### DETAILED DESCRIPTION OF EXAMPLE EMBODIMENTS OF THE INVENTION

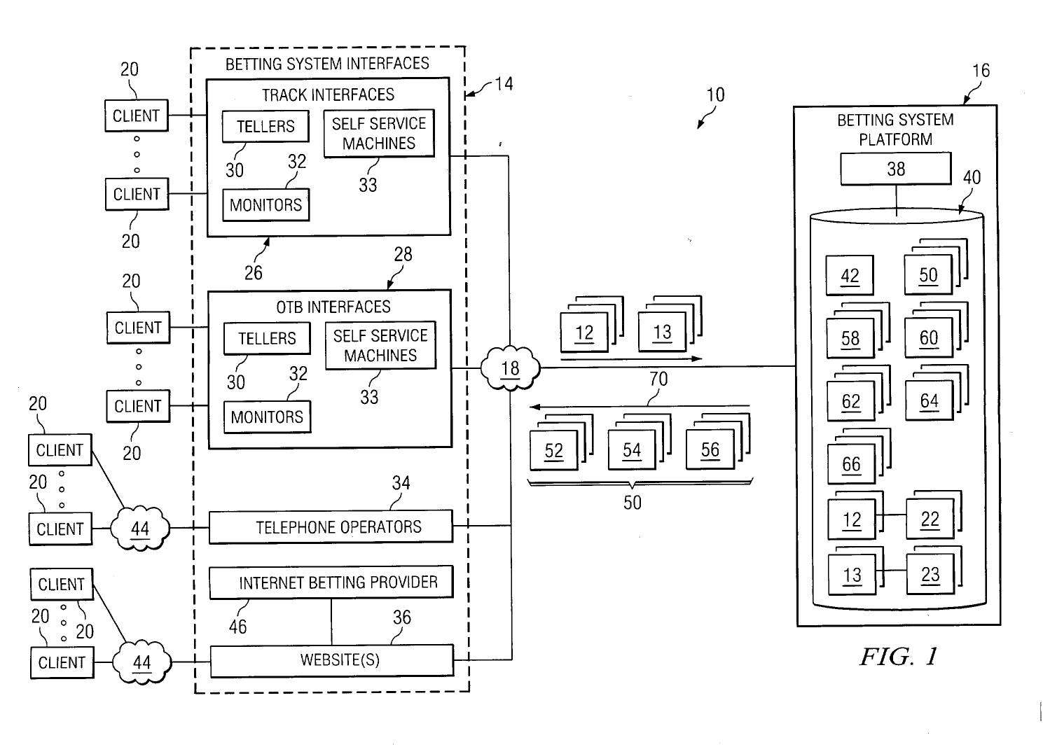

FIG. 1 illustrates an example system 10 for auctioning, managing, and paying bets 12 in accordance with an embodiment of the present invention. System 10 includes one or more betting system interfaces 14 and a betting system platform 16 coupled by one or more communication networks 18. In general, one or more clients 20 may receive betting information (such as event times, betting rules, betting options and odds, for example) and/or offer bids 13 in an auction via betting system interfaces 14. Betting system interfaces 14 communicate such bids 13 received from clients 20 to betting system platform 16. Betting system platform 16 stores the received bids 13 and determines bets 12 based upon bids 13. Platform 16 further determines and communicates appropriate odds and payouts to one or more of the betting system interfaces 14.

System 10 auctions bets 12 on an event, such as, for example, a race (e.g., horse race, dog race, auto race, etc.), a tournament (e.g., golf tournament, basketball tournament, soccer tournament, etc.), a game (e.g., football, baseball, basketball, hockey, soccer, etc.), or any other suitable competitive event, to the highest bidder for that bet 12. To bid, a client 20 posts the entire bid amount 23 at the time the bid 13 is made. If the client 20 is subsequently outbid, the client 20 is notified so that client 20 can either obtain a refund for the bid amount 23, or, if the auction is still open, post an additional bid amount 23 that will make the client 20 the highest bidder for the particular bet 12. The auction will close a predetermined amount of time before the start of the event, such as two minutes before the post-time of a horse race, in order to permit clients 20 who were outbid to make traditional bets 12 prior to the event. Therefore, clients 20 may check their bids 13 after the auction closes to confirm that they were the highest bidder for a bet 12 on an event; or, if they were not, to receive a refund of the bid amount 23. A bet 12 is associated with the client 20 that was the highest bidder for the bet 12 at the time the auction closed. The bet amount 22 is equal to the bid amount 23 that won the auction for that bet 12.

For example, in a five-horse race, if a first client 20 offers a first bid 13 for a bet 12 that Horse #1 will win the race, in the bid amount 23 of $200, and a second client 20 offers a second bid 13 for the bet 12 that Horse #1 will win the race, in the bid amount 23 of $500, then the first client 20 can either obtain a refund of the $200 bid amount 23 or, if the auction remains open, first client 20 can supplement the $200 in order to the outbid the second client 20. Assuming the first client 20 obtains the refund or that the auction was closed such that a supplemental bid 13 could not be made by first client 20, then second client 20 wins the auction for the bet 12 that Horse #1 will win the race. System 10 therefore accepts a bet 12 in a bet amount 22 of $500 from second client 20 that Horse #1 will win the race. Similar auctions may be held for bets 12 that other participants in the event, such as Horses #2-#5, will win the race. For example, the highest bid amount 23 for the bet that Horse #2 will win the race may be $200. The highest bid amount 23 for the bet that Horse #3 will win the race may be $100. The highest bid amount 23 for the bet that Horse #4 will win the race may be $300, and the highest bid amount 23 for the bet that Horse #5 will win the race may be $400. System 10 would therefore accept bets 12 in bet amounts 22 corresponding to the bid amounts 23 set forth above for Horses #2-#5. System 10 adds the bet amounts 22 resulting from the set of auctions described above regarding the winner of the race, to form a betting pool 54. The resulting betting pool 54 for the set of bets 12 described above may therefore be $1500 (minus any take-out or commission charged by the track or wagering facility).

In some embodiments, system 10 holds more than one auction for each event. For instance, an auction could be held every several minutes leading up to the start of the event. For example, when one auction closes, another auction could open. Alternatively, or in addition, auctions could run simultaneously with different closing times. Therefore, a separate betting pool 54 may be formed for each corresponding auction or set of auctions. For example, a second betting pool 54 in the amount of $2000 may be formed based on the following highest bid amounts 23 for the bets 12 that the stated horse will win the race: Horse #1-$400; Horse #2-$300; Horse #3-$300; Horse #4-$500; and Horse #5-$500. System 10 would therefore accept bets 12 in bet amounts 22 corresponding to the bid amounts 23 set forth above for Horses #1-#5. Each bet 12 accepted by system 10 is associated with the client 20 that made the corresponding highest bid amount 23.

Additional auctions may be held for the event with respect to bets 12 other than bets on the winner of an event. For example, auctions may be held for bets 12 on which participant will finish last in the event. Auctions may also be held for bets 12 on which participants will beat a particular score or time in the event. In this respect, auctions may be held for bets 12 on any number and combination of participants in an event and any number and combination of outcomes of the event, such as, for example, the finishing positions in the event, the finishing times in the event, the finishing scores in the event, etc.

The price a client 20 is willing to pay for a bet 12 on a particular participant in an event will necessarily reflect that participant's prospects of finishing with a desired outcome in the event, such as winning the event, coupled with the amount of money that could be won if the bet 12 is successful. System 10 may offer a predetermined minimum size betting pool 54 for any given auction or set of auctions. Therefore, in one embodiment, the track or wagering facility would be responsible for paying the predetermined minimum amount even if the betting pool 54 is less than this amount when the auction or set of auctions closes. In an alternative embodiment, if the betting pool 54 is less than the predetermined minimum amount, then system 10 may theoretically cancel all bets 12 for that auction or set of auctions and refund the bet amounts 22 to the appropriate clients 20. For example, if the auctions for the bets 12 on which participant will win the event does not yield some predetermined minimum betting pool 54, then system 10 can cancel all bets 12 associated therewith, and refund all bet amounts 22 and bid amounts 23. In this regard, no single client 20 will have to fear making a sizeable bid amount 23 early in the auction on the basis that other clients 20 will not back other participants in the event.

Betting system interfaces 14 may include any suitable interface between a client 20 and betting system platform 16. For example, as shown in FIG. 1, betting system interfaces 14 may include physical interfaces, such as track interfaces 26 and/or off-track interfaces 28. Track interfaces 26 are generally located at a track, while off-track interfaces 28 are generally located at an off-track-betting (OTB) establishment, such as an OTB parlor. Track interfaces 26 and off-track interfaces 28 may include tellers 30, which may receive bids 13 from and distribute payouts to clients 20, and/or monitors 32, which may be viewed by clients 20 to monitor betting information such as the event time, the current odds, and the projected or actual payouts for various bets 12, for example. In particular, system 10 may communicate betting information such as, for example, the pari-mutuel odds (e.g., odds on horses in a regular “win” betting pool); auction odds (e.g., odds on horses in an “auction” betting pool); the high bid on a particular bet being auctioned (e.g., the current high bid on the bet that Horse #3 will win the event); and total betting pools (e.g., the “win” betting pool and/or the “auction” betting pool 54). Armed with this information, bettors may perform “odds shopping” in order to make more informed decisions on whether to bid on a bet that a particular participant will win the event or to place a traditional “win” bet on that particular participant in that event. In some situations, such information may be updated substantially in real time or at preset intervals (such as every 30 seconds, for example) as new bets 12 are placed and/or as information regarding the event changes, for example. In certain situations, depending on the auction odds and the traditional pari-mutuel odds being offered, a bettor may be able to perform arbitrage betting such that the bettor places bets on each outcome in such a manner that whatever the outcome, the bettor will make a profit. Monitors 32 may include, for example, tote-boards or closed-circuit televisions located at a track or OTB establishment.

Track interfaces 26 and/or off-track interfaces 28 may also include one or more self-service betting machines 33. In some embodiment, self-service betting machines 33 allow clients 20 to insert payment into the machine (such as cash or by using a voucher or a credit or debit card), place one or more bets 12 and/or bids 13, and receive a printout (such as a ticket, for example) indicating the bets 12 or bids 13 placed. Printouts for refunded bids 13 and/or winning bets 12 may be inserted into the self-service betting machine, such as to receive a payment voucher (which may be used to receive a payout from a teller 30) or to place additional bets 12. In other embodiments, self-service betting machines 33 allow clients 20 to use a credit card, a debit card, or a smart card to place bets 12. The credit or debit card may have an associated account, which may be a betting account provided and/or managed by a betting account provider using, for example, a centralized computer system. The smart card may itself store information regarding a betting account and various bets, or may also be linked to a betting account using a centralized computer system. In some embodiments, after the betting event is completed, a client 20 may insert or swipe his or her credit, debit, or smart card in the self-service betting machines 33 in order to update the balance on the card. Self-service betting machines 33 may also allow the client 20 to print out payment vouchers which may be presented to a teller 30 in order to receive payments.

As shown in FIG. 1, betting system interfaces 14 may also include various non-physical interfaces, such as one or more telephone operators 34 and one or more websites 36. Clients 20 may access or communicate with such non-physical interfaces via one or more communication networks 44. Communication networks 44 may include one or more servers, routers, switches, repeaters, backbones, links and/or any other appropriate type of communication devices coupled by links such as wire line, optical, wireless, or other appropriate links. In general, communication network 44 may include any interconnection found on any communication network, such as a telephone network, a local area network (LAN), metropolitan area network (MAN), wide area network (WAN), the Internet, portions of the Internet, or any other data exchange system. To access betting system interface 14 using communication networks 44, clients 20 may use a computer, a personal digital assistant (pda), a cell-phone, a remote paging device, an electronic mail communication device, a handheld betting device, or any other suitable mobile device. In certain embodiments, clients 20 may receive any suitable information, such as betting information, from betting system platform 16 via mobile devices using, for example, communication networks 44 and betting system interfaces 14. Clients 20 may also receive notification via a mobile device that a bid 13 has been subsequently outbid. In this way, a client 20 has the opportunity to place another bid 13 or, at least, to collect a refund of the original bid 13.

Telephone operators 34 may communicate betting information to, and take bets 12 and/or bids 13 from, clients 20. Similarly, websites 36 may communicate betting information to clients 20 and allow clients 20 to place bets 12 and/or bids 13. One or more of such websites 36 may be hosted by one or more servers associated with system 10, which server or servers may also host betting system platform 16 in some embodiments. In some embodiments, betting information available to clients 20 via websites 36 may be updated substantially in real time or at preset intervals (such as every 30 seconds, for example) as new bets 12 are placed and/or as information regarding the event changes, for example.

In some embodiments, one or more websites 36 may be provided by, or associated with, an Internet betting provider 46, for example. Internet betting provider 46 may provide Internet account wagering by providing online betting accounts to one or more clients 20. Using an online betting account, a client 20 may interface with one or more websites 36 associated with the Internet betting provider 46 in order to fund the account, view betting information regarding betting events, and place bets 12 and/or bids 13. Such online betting accounts may include one or more various types of accounts, such as deposit accounts, credit accounts, stop-loss accounts, and hybrid accounts, for example.

As discussed above, betting system platform 16 is operable to receive bids 13 for bets 12 on an event from betting system interfaces 14, determine the bets 12 based on the bids 13, store the bets 12, determine appropriate odds and payouts, and communicate such odds and payouts to one or more of the betting system interfaces 14, which may then display such odds and/or payouts to clients 20. As shown in FIG. 1, betting system platform 16 includes a processor 38 coupled to a memory 40. Processor 38 is generally operable to execute various algorithms or calculations to determine current bet data 50, such as bet amounts 52, betting pools 54 and/or potential payout data 56.

As discussed above, betting system platform 16 comprises processor 38 and memory 40. Processor 38 may comprise any suitable processor that executes a betting system software application 42 or other computer instructions, such as a central processing unit (CPU) or other microprocessor, and may include any suitable number of processors working together. Memory 40 may comprise one or more memory devices suitable to facilitate execution of the computer instructions, such as one or more random access memories (RAMs), read-only memories (ROMs), dynamic random access memories (DRAMs), fast cycle RAMs (FCRAMs), static RAM (SRAMs), field-programmable gate arrays (FPGAs), erasable programmable read-only memories (EPROMs), electrically erasable programmable read-only memories (EEPROMs), microcontrollers, or microprocessors.

Memory 40 is generally operable to store various information that may be used by processor 38 in determining odds and/or payouts. For example, memory 40 may comprise any suitable number of databases, which may be co-located or physically and/or geographically distributed. In the example shown in FIG. 1, memory 40 may store any or all of the following: betting system software application 42, current bet data 50, one or more event parameters 58, one or more bet parameters 60, one or more calculation rules 62, one or more event results 64, and one or more bet results 66.

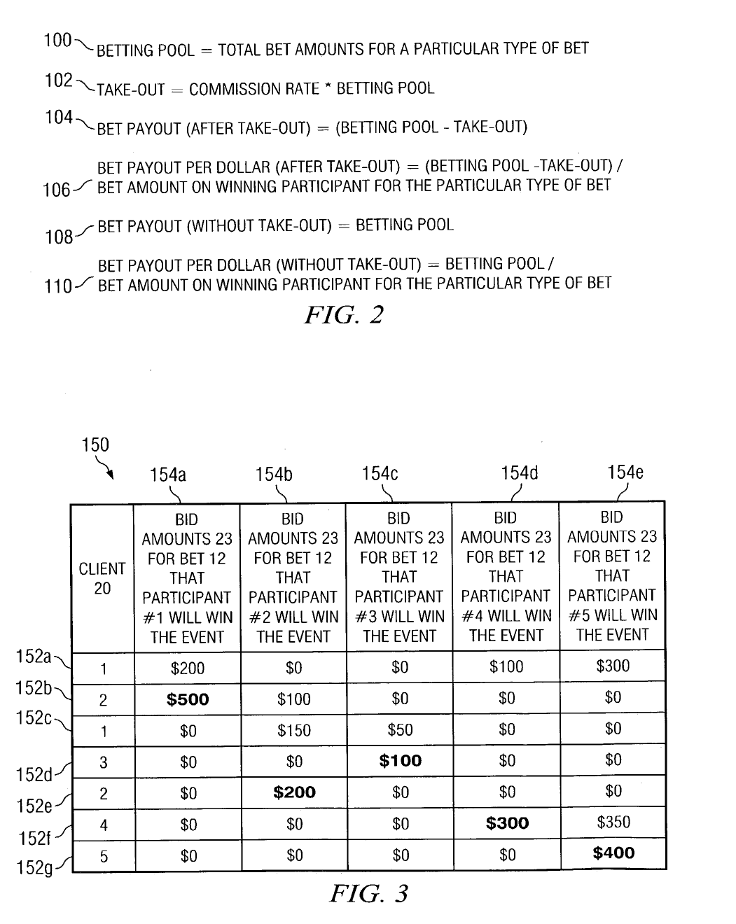

Event parameters 58 may comprise various parameters of one or more betting events, such as, for example, the type of event, the time, date and location of the event and/or the number (or in some cases, the name) of each of the participants in the event. Bet parameters 60 may comprise various parameters of one or more received bets 12, such as the identity of the client 20 who placed the bet 12, the manner in which the bet 12 was placed (such as via telephone, the Internet, or in person at a track or OTB establishment, for example), the type of bet 12, the commission rate on the bet 12, the participant or participants covered by the bet 12 and/or the amount of the bet 12, for example. Calculation rules 62 may comprise various equations or other algorithms to be used by processor 38 in determining various current bet data 50. Examples of such equations are illustrated and discussed below with reference to equations 100-110 of FIG. 2. Event results 64 may comprise various data regarding the results of one or more betting events, such as the final position of each participant in an event, the finishing score or time of a participant in the event, whether there was a tie for any position and/or whether any participants did not finish the event, for example. Bet results 66 may comprise various data regarding the results of various bets 12, such as the identity of the client 20 who placed the bet 12, whether the bet 12 was a winning bet, the determined payout for the bet 12 and/or whether the payout was distributed to the client 20, for example.

As discussed above, one or more communication networks 18 couple and facilitate wireless or wireline communication between one or more betting system interfaces 14 and betting system platform 16. Each communication network 18 may include one or more servers, routers, switches, repeaters, backbones, links and/or any other appropriate type of communication devices coupled by links such as wire line, optical, wireless, or other appropriate links. In general, each communication network 18 may include any interconnection found on any communication network, such as a local area network (LAN), metropolitan area network (MAN), wide area network (WAN), the Internet, portions of the Internet, or any other data exchange system.

As discussed above, processor 38 is operable to execute betting system software application 42 to determine current bet data 50, such as bet amounts 52, betting pools 54 and/or potential payout data 56. Processor 38 may determine such current bet data 50 based at least on data received from memory 40 and/or one or more betting system interfaces 14. In addition, processor 38 may update such current bet data 50 based on new information being received by betting system platform 16. In some embodiments, processor 38 may update current bet data 50 in real time, substantially in real time, or at preset intervals (such as every 30 seconds, for example).

As shown in FIG. 1, current bet data 50 may be communicated to one or more betting system interfaces 14 via communication network 18, as indicated by arrow 70. Current bet data 50 may then be made available to clients 20, such as via tote boards or monitors 32 located at a track or OTB establishment, for example, or on an appropriate website 36 that may be accessed by clients 20, for example. In this manner, clients 20 may have access to real-time or substantially real-time current bet data 50 regarding various betting events.

As discussed above, processor 38 may calculate various current bet data 50 using various algorithms or equations. FIG. 2 illustrates examples of such algorithms or equations in accordance with one embodiment of the present invention. In particular, FIG. 2 illustrates various equations for calculating the current potential payout 56 for each bet 12, associated with a particular betting event. In particular, FIG. 2 illustrates a Betting Pool equation 100, a Take-Out equation 102, a Bet Payout (after Take-Out) equation 104, a Bet Payout Per Dollar (after Take-Out) equation 106, a Bet Payout (without Take-Out) equation 108, and a Bet Payout Per Dollar (without Take-Out) equation 110. The equations shown in FIG. 2 are best understood when viewed in conjunction with FIG. 3.

FIG. 3 illustrates a table 150 comprising example bids 13 and bid amounts 23 in auctions for bets 12 that particular participants will win an event. For example, each row 152 of table 150 identifies a particular client 20 making bids 13, the bid amount 23 of each bid 13, and the particular bets 12 being auctioned on which the bids 13 are made. Each column 154 of table 150 is associated with a particular bet 12 that a particular participant will win the event, and identifies the various bids 13 and bid amounts 23 made by clients 20 in the auction for that bet 12. For example, system 10 holds a separate auction for each of the five bets 12 represented by columns 154a-e. The winner of each auction is the client 20 that has the highest bid amount 23 at the close of that auction. System 10 accepts a bet 12 associated with the client 20 that wins a given auction. The bet amount 22 of each bet 12 is therefore the bid amount 23 that was the highest bid 13 in the given auction. A betting pool 54 is formed by adding each of the determined bet amounts 22 from each of the auctions corresponding to the five bets 12 represented by columns 154a-e.

For example, column 154a represents a bet 12 that Participant #1 will win the event. Row 152a indicates that client 20 #1 has offered a bid 13 in a bid amount 23 of $200 for bet 12 of column 154a. Row 152b indicates that client 20 #2 has offered a bid 13 in a bid amount 23 of $500 for bet 12 of column 154a. The remaining rows 152 of table 150 indicate that no other clients 20 have submitted bids 13 on the bet 12 of column 154a, and that client 20 #1 has not countered the bid 13 of client 20 #2. Therefore, client 20 #2 wins the auction for the bet 12 that Participant #1 will win the event. System 10 therefore accepts a bet 12 that Participant #1 will win the event and associates this bet 12 with client 20 #2. The bet amount 22 of this bet 12 is $500 (as indicated in bold in FIG. 3), which is added to the betting pool 54 for the set of bets 12 regarding which participant will win the event. The betting pool 54 is therefore $500.

Column 154b represents a bet 12 that Participant #2 will win the event. Row 152b indicates that client 20 #2 has offered a bid 13 in a bid amount 23 of $100 for bet 12 of column 154b. Row 152c indicates that client 20 #1 has offered a bid 13 in a bid amount 23 of $150 for bet 12 of column 154b. Row 152e indicates that client 20 #2 has countered the bid 13 of client 20 #1 with a bid 13 in a bid amount 23 of $200. The remaining rows 152 of table 150 indicate that no other clients 20 have offered a bid 13 on the bet 12 of column 154b, and that client 20 #1 has not countered the bid 13 of client 20 #2. Therefore, client 20 #2 wins the auction for the bet 12 that Participant #2 will win the event. System 10 therefore accepts a bet 12 that Participant #2 will win the event and associates this bet 12 with client 20 #2. The bet amount 22 of this bet 12 is $200 (as indicated in bold in FIG. 3), which is added to the betting pool 54 for the set of bets 12 regarding which participant will win the event. The betting pool 54 is therefore $700.

Column 154c represents a bet 12 that Participant #3 will win the event. Row 152c indicates that client 20 #1 has offered a bid 13 in a bid amount 23 of $50 for bet 12 of column 154c. Row 152d indicates that client 20 #3 has offered a bid 13 in a bid amount 23 of $100 for bet 12 of column 154c. The remaining rows 152 of table 150 indicate that no other clients 20 have submitted bids 13 on the bet 12 of column 154c, and that client 20 #1 has not countered bid 13 made by client 20 #3. Therefore, client 20 #3 wins the auction for the bet 12 that Participant #3 will win the event. System 10 therefore accepts a bet 12 that Participant #3 will win the event and associates this bet 12 with client 20 #3. The bet amount 22 of this bet 12 is $100 (as indicated in bold in FIG. 3), which is added to the betting pool 54 for the set of bets 12 regarding which participant will win the event. The betting pool 54 is therefore $800.

Column 154d represents a bet 12 that Participant #4 will win the event. Row 152a indicates that client 20 #1 has offered a bid 13 in a bid amount 23 of $100 for bet 12 of column 154d. Row 152f indicates that client 20 #4 has offered a bid 13 in a bid amount 23 of $300 for bet 12 of column 154d. The remaining rows 152 of table 150 indicate that no other clients 20 have submitted bids 13 on the bet 12 of column 154d, and that client 20 #1 has not countered bid 13 made by client 20 #4. Therefore, client 20 #4 wins the auction for the bet 12 that Participant #4 will win the event. System 10 therefore accepts a bet 12 that Participant #4 will win the event and associates this bet 12 with client 20 #4. The bet amount 22 of this bet 12 is $300 (as indicated in bold in FIG. 3), which is added to the betting pool 54 for the set of bets 12 regarding which participant will win the event. The betting pool 54 is therefore $1,100.

Column 154e represents a bet 12 that Participant #5 will win the event. Row 152a indicates that client 20 #1 has offered a bid 13 in a bid amount 23 of $300 for bet 12 of column 154e. Row 152f indicates that client 20 #4 has offered a bid 13 in a bid amount 23 of $350 for bet 12 of column 154e. Row 152g indicates that client 20 #5 has offered a bid 13 in a bid amount 23 of $400 for bet 12 of column 154e. The remaining rows 152 of table 150 indicate that no other clients 20 have submitted bids 13 on the bet 12 of column 154e, and that neither client 20 #1 nor client 20 #4 has countered bid 13 made by client 20 #5. Therefore, client 20 #5 wins the auction for the bet 12 that Participant #5 will win the event. System 10 therefore accepts a bet 12 that Participant #5 will win the event and associates this bet 12 with client 20 #5. The bet amount 22 of this bet 12 is $400 (as indicated in bold in FIG. 3), which is added to the betting pool 54 for the set of bets 12 regarding which participant will win the event. The final betting pool 54 is therefore $1,500.

The take-out for this betting pool 54 may be calculated to be $225 using equation 102 if we assume a 15% commission rate, for example. The payout for the bets 12 after take-out can be calculated to be $1,500-$225=$1,275 using equation 104. Of course, without take-out, the payout for the bets 12 is calculated to be $1,500 using equation 108.

The payout per dollar for the bets 12 after take-out can be calculated using equation 106 to be the following amounts based on the winning participant of the event:

Participant #1 wins event —$1,275/$500=$2.55

Participant #2 wins event —$1,275/$200=$6.37

Participant #3 wins event —$1,275/$100=$12.75

Participant #4 wins event $1,275/$300=$4.25

Participant #5 wins event $1,275/$400=$3.18

The payout per dollar for the bets 12 without take-out can be calculated using equation 110 to be the following amounts based on the winning participant of the event:

Participant #1 wins event —$1,500/$500=$3.00

Participant #2 wins event —$1,500/$200=$7.50

Participant #3 wins event —$1,500/$100=$15.00

Participant #4 wins event —$1,500/$300=$5.00

Participant #5 wins event —$1,500/$400=$3.75

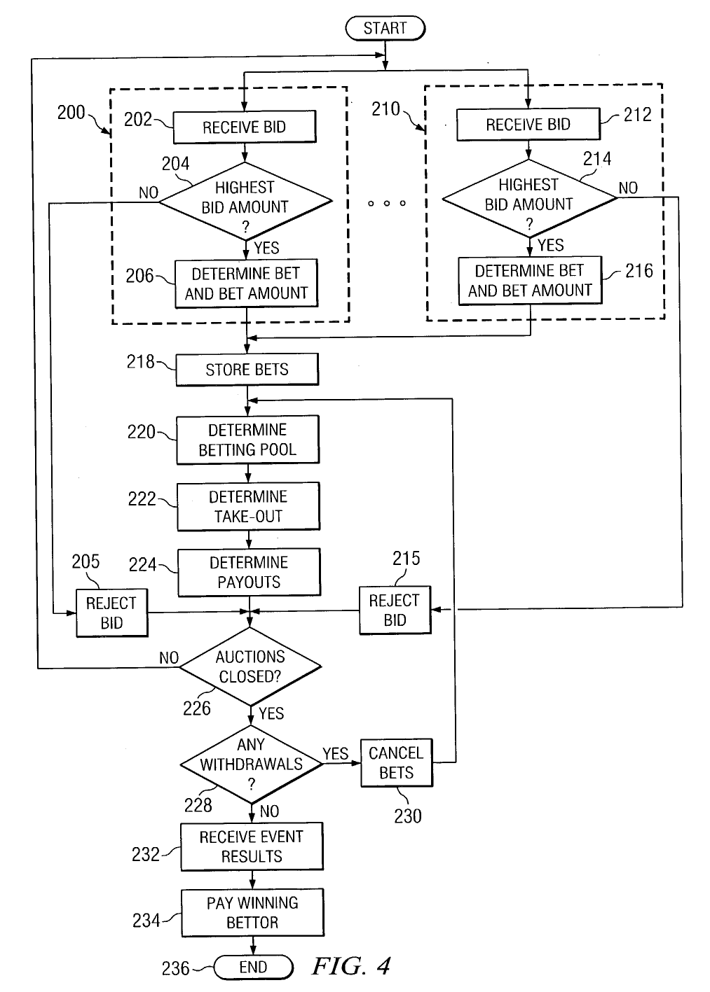

FIG. 4 is a flowchart illustrating an example method of auctioning, managing, and paying bets 12 in accordance with an embodiment of the present invention. System 10 auctions a first bet 12 to one of a plurality of clients 20 for a bet amount 22 at steps 200. System 10 auctions an Nth bet 12 to one of the clients 20 for a bet amount 22 at steps 210. System 10 could auction other bets 12 to other clients 20 as indicated by the ellipses between steps 200 and 210. In some situations, steps 200 and 210 may occur simultaneously, or may at least partially overlap. The bets 12 associated with steps 200 and 210 are related and comprise bets 12 regarding a particular outcome of an event. For example, the bets 12 could be based upon the winner of a five horse race. Therefore, the bet 12 of steps 200 could be a bet 12 that Horse #1 will win a particular horse race. The bet 12 of steps 210 could be a bet 12 that Horse #5 will win the horse race. The bets 12 indicated by the ellipses between steps 200 and 210 could be bets 12 that Horses #2-#4 will win the horse race.

Referring to steps 200, system 10 receives a bid 13 on the bet 12 that Horse #1 will win the horse race at step 202. At step 204, system 10 determines whether the bid 13 received at step 202 is the highest bid amount 23 among the rest of the bids 13 received in steps 200. If not, bid 13 is rejected at step 205 and execution proceeds to step 226 where system 10 determines whether the auction for the bet 12 that Horse #1 will win the horse race has closed. If the auction has not closed, additional bids 13 may be received by system 10. If the bid 13 received at step 202 is the highest bid amount 23, as determined at step 204, then execution proceeds to step 206 where system 10 determines bet 12 and bet amount 22 based upon the bid 13 received at step 202. In particular, system 10 associates bet 12 with the client 20 that placed the bid 13 received at step 202, and the bet amount 22 equals the bid amount 23 of the bid 13.

Referring to steps 210, system 10 receives a bid 13 on the bet 12 that Horse #5 will win the horse race at step 212. At step 214, system 10 determines whether the bid 13 received at step 212 is the highest bid amount 23 among the rest of the bids 13 received in steps 210. If not, bid 13 is rejected at step 215 and execution proceeds to step 226 where system 10 determines whether the auction for the bet 12 that Horse #5 will win the horse race has closed. If the auction has not closed, additional bids 13 may be received by system 10. If the bid 13 received at step 212 is the highest bid amount 23, as determined at step 214, then execution proceeds to step 216 where system 10 determines bet 12 and bet amount 22 based upon the bid 13 received at step 212. In particular, system 10 associates bet 12 with the client 20 that placed the bid 13 received at step 212, and the bet amount 22 equals the bid amount 23 of the bid 13.

System 10 may determine bets 12 and bet amounts 22 for the remaining Horses #2-#4 as indicated by the ellipses between steps 200 and 210. Execution proceeds to step 218 where system 10 stores the bets 12 determined above. System 10 determines betting pool 54 based upon the bet amounts 22 determined above, at step 220. At step 222, system 10 determines the take-out based upon a suitable commission rate and the betting pool determined at step 220. System 10 determines payouts at step 224 using, for example, the equations from FIG. 2.

System 10 determines whether the auctions of steps 200 and 210 have closed at step 226. If not, execution returns to steps 200 and 210 where system 10 may receive additional bids 13 for corresponding bets on the event. If the auctions have closed, then execution proceeds to step 228 where system 10 determines whether any of the participants in the event will not be competing in the event, such as if a participant is scratched, withdrawn, or becomes a non-runner, for example. For example, betting system platform 16 may receive a notification that one or more of the participants has been withdrawn from the event prior to the start of the event. If it is determined at step 228 that one or more participants will not be competing in the event, execution proceeds to step 230 where the appropriate bets 12 are canceled. From here, execution returns to step 220 where the betting pool 220 is updated to reflect the canceled bets 12. In certain circumstances, a particular betting pool 54 may be terminated and the bet amounts 22 associated with that betting pool 54 may be refunded to clients 20. Otherwise, the method proceeds to step 232 where the results of the event are received, such as the final position of each participant in the event and whether there was a tie for any position, for example. At step 234, the payouts are paid to clients 20 who made successful bets 12. The method terminates at step 236.

Although embodiments of the invention and their advantages are described in detail, a person skilled in the art could make various alterations, additions, and omissions without departing from the spirit and scope of the present invention as defined by the appended claims.

What is claimed is:

1. A method of managing bets, comprising:
receiving a first bid identifying a first bid amount and a first participant of a plurality of participants in an event;
receiving a second bid identifying a second bid amount and the first participant;
storing a first bet associated with a first bet amount, wherein the first bet comprises a bet that the first participant will finish in a particular finishing position associated with the event and wherein the first bet amount comprises the greater of the first bid amount and the second bid amount;
receiving a third bid identifying a third bid amount and a second participant of the plurality of participants in an event;
receiving a fourth bid identifying a fourth bid amount and the second participant;
storing a second bet associated with a second bet amount, wherein the second bet comprises a bet that the second participant will finish in the finishing particular position associated with the event and wherein the second bet amount comprises the greater of the third bid amount and the fourth bid amount;
adding the first bet amount and the second bet amount to form a betting pool; and
determining an amount of a payout based at least in part on the betting pool.

2. The method of claim 1, wherein:
the first bid is associated with a first client;
the second bid is associated with a second client;
the first bid amount is greater than the second bid amount; and
the first bet is associated with the first client.

3. The method of claim 1, further comprising:
receiving a fifth bid identifying a fifth bid amount and a third participant of the plurality of participants in an event;
receiving a sixth bid identifying a sixth bid amount and the third participant; and
storing a third bet associated with a third bet amount, wherein the third bet comprises a bet that the third participant will finish in the particular finishing position associated with the event and wherein the third bet amount comprises the greater of the fifth bid amount and the sixth bid amount;
wherein adding comprising adding the first bet amount with the second bet amount and the third bet amount to form the betting pool.

4. The method of claim 1, wherein the finishing position associated with the event comprises first place in the event.

5. The method of claim 2, further comprising:
notifying the first client and the second client that the first bet is associated with the first client;
receiving a fifth bid from the second client, the fifth bid identifying the first participant and a fifth bid amount greater than the first bid amount; and
associating the first bet with the second client such that the first bet amount comprises the fifth bid amount.

6. The method of claim 1, further comprising:
receiving a first payment for the first bid amount from a first client;
receiving a second payment for the second bid amount from a second client;
determining that the first bid amount is greater than the second bid amount such that the first bet is associated with the first client; and
refunding the second payment for the second bid amount to the second client.

7. The method of claim 1, wherein the betting pool comprises a first betting pool associated with the event and the payout comprises a first payout associated with the event, the method further comprising:
generating a second betting pool associated with the event based at least in part upon additional bids associated with the first participant and the second participant; and
determining an amount of a second payout based at least in part upon the second betting pool.

8. The method of claim 1, further comprising canceling the first bet and the second bet if the betting pool does not exceed a predetermined amount.

9. The method of claim 1, wherein at least one of the first bid, the second bid, the third bid, and the fourth bid are received using an online communication network.

10. A system for managing bets, comprising:
a memory operable to store:
a first bid identifying a first bid amount and a first participant of a plurality of participants in an event;
a second bid identifying a second bid amount and the first participant;
a first bet associated with a first bet amount, wherein the first bet comprises a bet that the first participant will finish in a particular finishing position associated with the event and wherein the first bet amount comprises the greater of the first bid amount and the second bid amount;
a third bid identifying a third bid amount and a second participant of the plurality of participants in an event;
a fourth bid identifying a fourth bid amount and the second participant; and
a second bet associated with a second bet amount, wherein the second bet comprises a bet that the second participant will finish in the finishing particular position associated with the event and wherein the second bet amount comprises the greater of the third bid amount and the fourth bid amount; and
a processor operable to:
add the first bet amount and the second bet amount to form a betting pool; and
determine an amount of a payout based at least in part on the betting pool.

11. The system of claim 10, wherein:
the first bid is associated with a first client;
the second bid is associated with a second client;
the first bid amount is greater than the second bid amount; and
the first bet is associated with the first client.

12. The system of claim 10, wherein:
the memory is further operable to store:
a fifth bid identifying a fifth bid amount and a third participant of the plurality of participants in an event;
a sixth bid identifying a sixth bid amount and the third participant; and
a third bet associated with a third bet amount, wherein the third bet comprises a bet that the third participant will finish in the particular finishing position associated with the event and wherein the third bet amount comprises the greater of the fifth bid amount and the sixth bid amount; and
the processor adds the first bet amount with the second bet amount and the third bet amount to form the betting pool.

13. The system of claim 10, wherein the finishing position associated with the event comprises first place in the event.

14. The system of claim 11, wherein the processor is further operable to:
notify the first client and the second client that the first bet is associated with the first client;
receive a fifth bid from the second client, the fifth bid identifying the first participant and a fifth bid amount greater than the first bid amount; and
associate the first bet with the second client such that the first bet amount comprises the fifth bid amount.

15. The system of claim 10, further comprising a clearinghouse operable to:
receive a first payment for the first bid amount from a first client;
receive a second payment for the second bid amount from a second client; and
refund the second payment for the second bid amount to the second client if the first bid amount is greater than the second bid amount.

16. The system of claim 10, wherein the betting pool comprises a first betting pool associated with the event and the payout comprises a first payout associated with the event, and wherein the processor is further operable to:
generate a second betting pool associated with the event based at least in part upon additional bids associated with the first participant and the second participant; and
determine an amount of a second payout based at least in part upon the second betting pool.

17. The system of claim 10, wherein the processor cancels the first bet and the second bet if the betting pool does not exceed a predetermined amount.

18. The system of claim 10, wherein at least one of the first bid, the second bid, the third bid, and the fourth bid are received by the processor using an online communication network.

19. A method of managing bets, comprising:
auctioning a first bet to one of a plurality of clients for a first bet amount, wherein the first bet comprises a bet that a first participant will finish in a particular finishing position associated with an event;
auctioning a second bet to one of a plurality of clients for a second bet amount, wherein the second bet comprises a bet that a second participant will finish in the particular finishing position associated with the event;
adding the first bet amount and the second bet amount to form a betting pool; and
determining an amount of a payout based at least in part on the betting pool.

20. The method of claim 19, wherein auctioning the first bet comprises:
receiving a first bid identifying a first bid amount and the first participant;
receiving a second bid identifying a second bid amount and the first participant;
associating the first bet amount with the greater of the first bid amount and the second bid amount.

21. The method of claim 20, wherein:
the first bid is associated with a first client;
the second bid is associated with a second client;
the first bid amount is greater than the second bid amount; and
the first bet is associated with the first client.

22. The method of claim 19, further comprising auctioning a third bet to one of a plurality of clients for a third bet amount wherein the third bet comprises a bet that a third participant will finish in the particular finishing position associated with the event, wherein adding comprises adding the first bet amount with the second bet amount and the third bet amount.

23. The method of claim 19, wherein the finishing position associated with the event comprises first place in the event.

24. The method of claim 21, further comprising notifying the first client and the second client that the first bet is associated with the first client, wherein auctioning the first bet further comprises receiving a third bid from the second client, the third bid identifying the first participant and a third bid amount greater than the first bid amount.

25. The method of claim 24, further comprising associating the first bet with the second client such that the first bet amount comprises the third bid amount.

26. The method of claim 20, wherein auctioning the first bet further comprises:
receiving a first payment for the first bid amount from a first client;
receiving a second payment for the second bid amount from a second client;
determining that the first bid amount is greater than the second bid amount such that the first bet is associated with the first client; and
refunding the second payment for the second bid amount to the second client.

27. The method of claim 19, wherein the betting pool comprises a first betting pool associated with the event and the payout comprises a first payout associated with the event, the method further comprising:
generating a second betting pool associated with the event based at least in part upon additional bids associated with the first participant and the second participant; and
determining an amount of a second payout based at least in part upon the second betting pool.

28. The method of claim 19, further comprising canceling the first bet and the second bet if the betting pool does not exceed a predetermined amount.

29. The method of claim 20, wherein at least one of the first bid and the second bid are received using an online communication network.
